(19) United States
(12) Patent Application Publication
(10) Pub. No.: US 2019/0034951 A1
(43) Pub. Date: Jan. 31, 2019

(54) SYSTEMS AND METHODS FOR MANAGING RETAIL OPERATIONS USING BEHAVIORAL ANALYSIS OF NET PROMOTER CATEGORIES

(71) Applicant: Symphony EYC, Atlanta, GA (US)

(72) Inventor: Withiel Cole, Cirencester (GB)

(73) Assignee: Symphony EYC, Atlanta, GA (US)

(21) Appl. No.: 15/878,275

(22) Filed: Jan. 23, 2018

Related U.S. Application Data
(60) Provisional application No. 62/449,406, filed on Jan. 23, 2017.

(51) Int. Cl. G06Q 30/02; G06Q 10/06

(52) U.S. Cl. CPC G06Q 30/0224; G06Q 30/0231; G06Q 30/0214; G06Q 10/06393; G06Q 30/0202

(57) ABSTRACT

Systems and methods for optimizing retail store management by identifying customers whose behaviors more likely make them to be net promoters (regardless of the buying habits), by using enhanced customer segmentation and responsive detailed customer behavioral modeling systems to create behavioral promoter scores capable of sensitivity segmentation, and to detect key drivers (price, promotion, choice, quality) that have potential opportunity for improvement. In addition, the system is capable of determining the reason why the area is performing in a given manner and how the retailer may improve the performance of the area.

### CROSS-REFERENCE

Priority is claimed from U.S. application 62/449,406 filed on Jan. 23, 2017 (Att'y Docket No. SEYC-11-P), which is hereby incorporated by reference.

### BACKGROUND

The present applications discloses new kinds of computer systems and methods for managing a retail operation.

Note that the points discussed below may reflect the hindsight gained from the disclosed inventions, and are not necessarily admitted to be prior art.

It has long been known that some retail customers are “promoters,” who can leverage other customers to come to a successful retail operation. These promoters are critical to the economic success of the retail operation. Much marketing analysis has, therefore been devoted to obtaining a “net promoter score” which provides a metric for identifying “net promoter” customers. Questionnaires have commonly been used to identify the “promoter” customers, and some of these provide a net promoter score for a set of customer responses.

Where customer data can be captured, e.g. through a loyalty card program, the buying habits of a particular customer can be tracked. The customers with the heaviest buying habits at a particular retail environment will often (but not always) be the net promoters.

The present application discloses systems and methods for better management of retail operations. Among other points, the present application teaches that net promoter score is too coarse a metric for optimal handling of customers: in addition to net promoter scoring, different customers' sensitivities to different elements of the retailer's proposition are also included. (For example, some customers will be more sensitive to price, some to quality, some to promotions, etc.) Some of these sensitivities will depend on the particular product segment, so analysis down to the level of store+segment+product type is helpful.

A tactical goal in retail management is 1) converting battleground customers to heartland customers, while 2) minimizing erosion of the base of heartland customers.

Monitoring the behavior of customers with different sensitivities is particularly useful with “battleground” customers. Since battleground customers are known to have exposure to other retailers' strategies, they, more than the “heartland” customers, can provide a rapid view of customer movement (and corresponding opportunities and vulnerabilities). Thus close analysis of the behavior of battleground customers not only provides opportunities for immediate revenue improvement, but also provides a longer-term view into the health of the core group of heartland customers.

(In the present application, the customers who are loyal net promoters are referred to as “primary” or “heartland” or “promoter” customers; those who show signs of potential heavy buying, but are not necessarily loyal, are referred to as “secondary” or “battlefield” or “detractor” customers; customers who do not fall within either of these categories may be referred to as “tertiary” or “wilderness” customers.)

The present application teaches that the customers will have different sensitivities, which can be identified and tracked by customer and by product segment. In particular these sensitivies are to the elements of their proposition that retailers focus on to gain competitive advantage—namely price, promotions, choice, quality service etc. Detailed understanding of these sensitivities provides useful information in optimizing retail store management.

The present application also discloses computer systems, which improve the identification and management of net promoter customers, as well as customers who are less committed or not committed to a particular retail environment, and of the sensitivities of identified customer segments (as defined by additional parameters, as described above).

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 is an overall hierarchy of the system and method in accordance with a preferred embodiment.

FIG. 2A shows a calculation of the Behavioral Promoter Score using the system and method in accordance with the preferred embodiment.

FIG. 2B shows a diagram of how promoters and detractors are calculated in accordance with the preferred embodiment.

FIG. 3 is a flow chart depicting an enhanced customer segmentation (FACTS) in accordance with the preferred embodiment.

FIG. 4A is a chart showing likelihood to be a Net Promoter in accordance with the preferred embodiment.

FIG. 4B is a chart showing ability to drive revenues/margins in accordance with the preferred embodiment.

FIG. 4C is a chart showing satisfaction with drivers in accordance with the preferred embodiment.

FIG. 5 is a flow chart depicting a sample determination of customer sensitivity using a customer behavioral model in accordance with the preferred embodiment.

FIG. 6A, 6B, and 6C are charts showing how driver segmentation allows improved diagnosis in accordance with the preferred embodiment.

FIG. 7 shows an example of how FACTS data enables the system to identify opportunities in a competitive environment by understanding performance in accordance with the preferred embodiment.

FIG. 8 shows an example of how the system can find weak performance in sensitivity segments even when the overall retailer is showing strong performance in accordance with the preferred embodiment.

FIG. 9 shows an example of the system detailing what promotional activities likely caused the decline in the “battleground” customers in accordance with the preferred embodiment.

FIG. 10 shows the system is able to compare the number of promotions for declining sales items from year to year for analysis purposes in accordance with the preferred embodiment.

FIG. 11 shows the system is able to system is able to perform gap analysis in accordance with the preferred embodiment.

FIG. 12 shows the system is able to determine a reason for the gap between “heartland” and “battleground” customers analysis in accordance with the preferred embodiment.

FIG. 13 shows the system offers the retailer a better understanding of their customer base allowing the retailer store to compete better locally in accordance with the preferred embodiment.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application teaches that customers whose behavior matches certain profiles are more likely to be net promoters, regardless of their buying habits. The group of customers, which have high net promoter scores and consistently heavy buying habits, are an important component of growth for a retail operation.

In addition this application demonstrates that those customers who are detractors offer a significant opportunity for a retailer. These customers are more influenced by relative-competitive propositions, and will respond rapidly to influences in the marketplace.

The present application teaches that customers will have different sensitivities, which can be identified and tracked by customer and by product segment, to provide useful information in optimizing retail store management.

For example, some important categories of customer sensitivities are price, promotion, quality, and variety. By tracking the behavior of customers who are net promoters or detractors, and comparing their behavior with those customers who are not yet net promoters, and important information can be derived for use in optimizing the retail operation.

The distinction between “heartland”/“promoter” customers and “battleground”/“detractor” customers is important. One major difference between a “heartland” customer and a “battleground” customer is their usage of the retailer as a primary source of basic goods. A “heartland” customer will consistently purchase basic goods such as milk, butter, bread, and eggs whereas a “battleground” customer will only purchase basic goods from the retailer intermittently. The same metrics, which are used to identify high-volume net promoter customers, can also identify customers whose buying patterns are inconsistent over time in the areas where consistency would be expected. For example, in a grocery operation, a customer who buys three gallons of milk per week for weeks or months, and then stops buying milk from this operation, has probably gone to another vendor to buy milk.

The present application discloses computer systems and methods which improve the identification and management of net promoter customers, as well as customers who are less committed or not committed to a particular retail environment, as well as business methods which make use of such computer systems and methods.

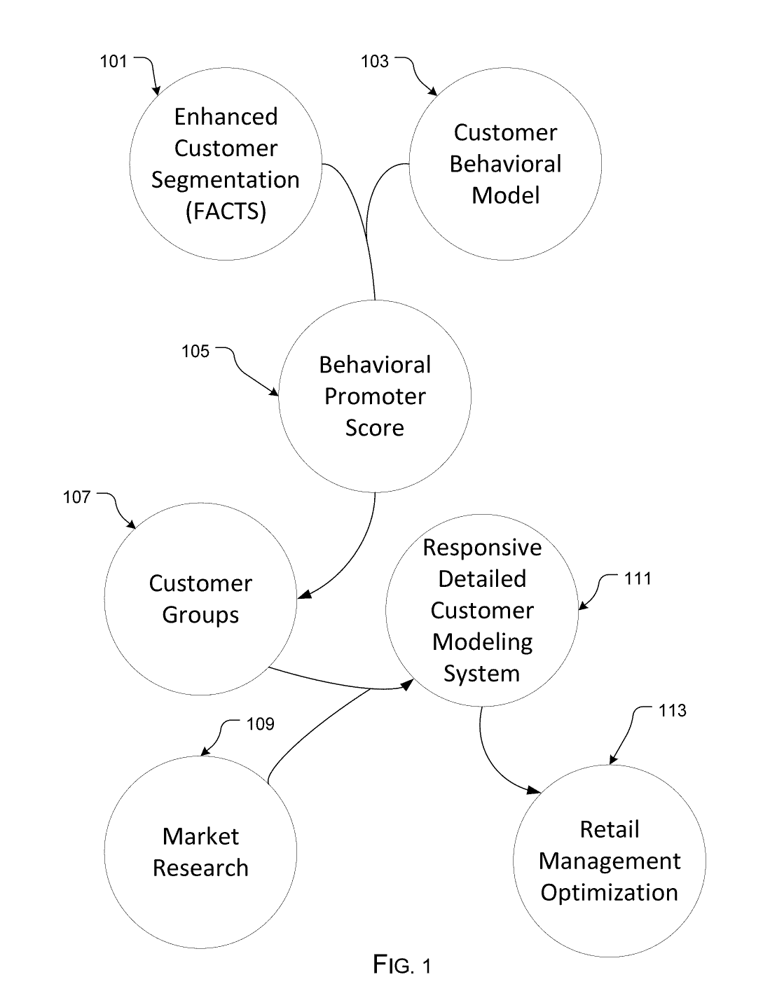

FIG. 1 is an overall hierarchy of the system and method in accordance with a preferred embodiment. The first element is an enhanced customer segmentation element, based on FACTS (101). “FACTS” is a mnemonic acronym which refers to: the Frequency of customer visits, Advocated Categories the customer buys, Total Spend of the customer; these elements give some overall understanding of customers' engagement and satisfaction with a retailer. FACTS 101 is merged with the customer behavioral models (103) which determine the customer's sensitivities. Together FACTS 101 and the customer behavioral models 103 form the framework that enables detailed diagnosis of retailer performance (105). The Behavioral Promoter Score 105 is calculated based on research and behavioral data creating a unique platform enabling retailers to diagnose and respond to performance in a competitive market. Once the Behavioral Promoter Score 105 has been calculated, customer groups 107 are identifiable. Data from the customer groups 107 along with market research (109) combine in the responsive detailed customer modeling system (111), which is a series of detailed models that determine the relative importance of components of a retailer's proposition enabling a retailer to track and amend performance in response to customers' behavioral changes in competitive markets. The responsive customer modeling system 111 allows for retail management optimization (113).

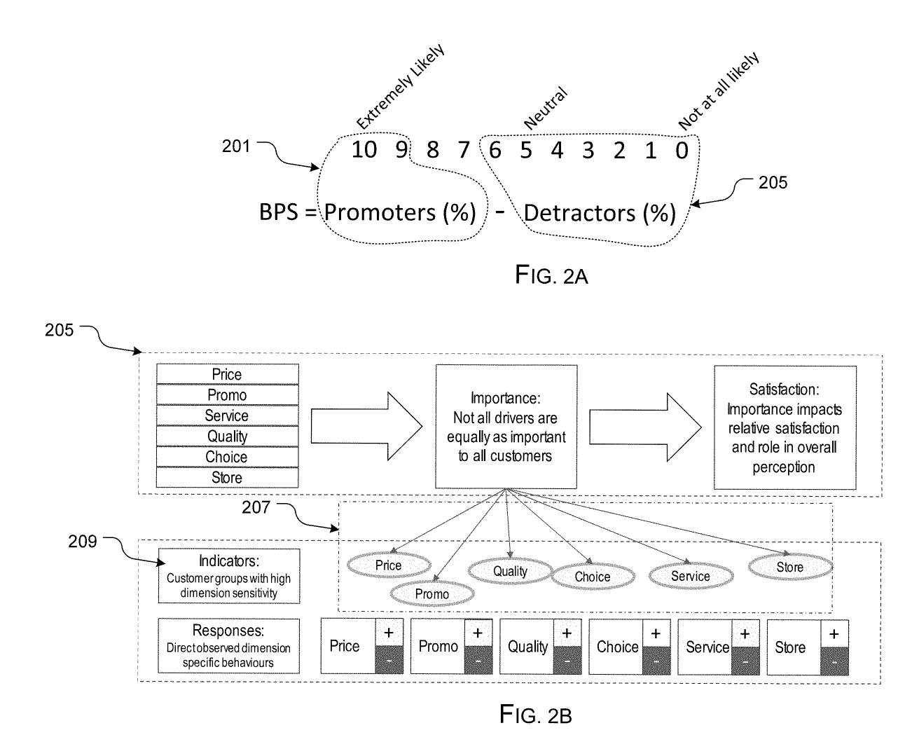

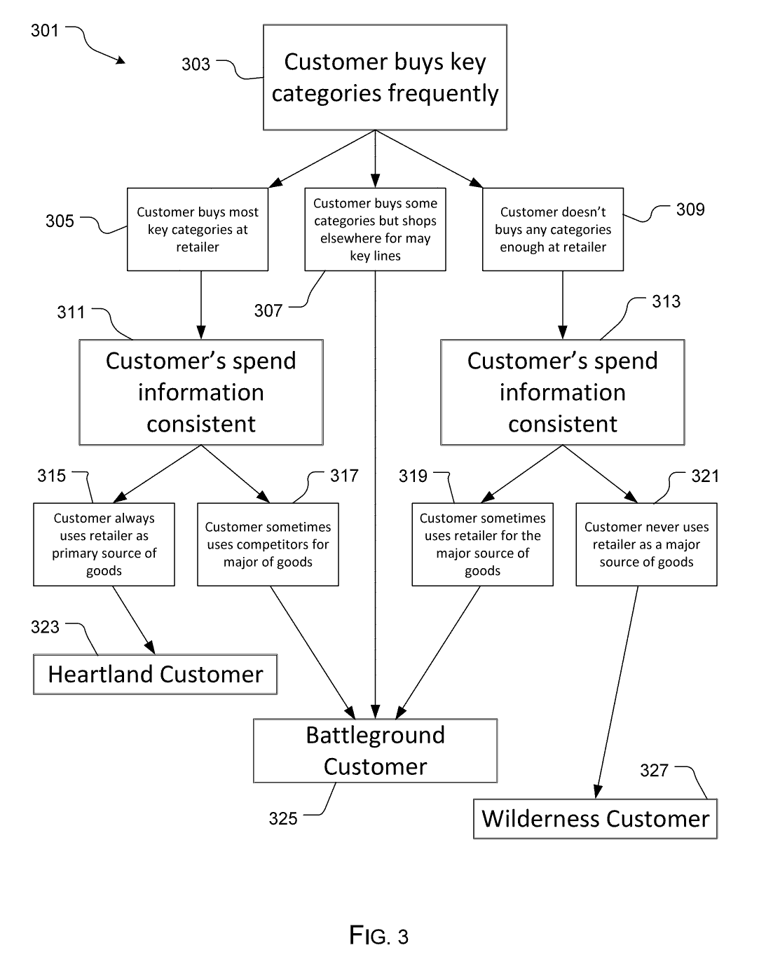

FIG. 2A shows calculation of a Behavioral Promoter Score (“BPS”). Within a given identified customer segment (which may be delimited by store and by product category), the fraction of promoters (201) is subtracted from the fraction of detractors (203). Promoters 201 are customers whose behaviors lead to new markets and increased revenues for the retailer, while detractors 203 are customers who require a change in proposition from the retailer to prevent them from reducing the retailer's revenues. Customers who are neither promoters 201 nor detractors 203 are considered passives (not depicted) and do not influence the Behavioral Promoter Score. These customers are unengaged with a retailer and unable to review its proposition within a competitive environment. It should be appreciated that one important part of calculating the Behavioral Promoter Score is the method that is used in calculating promoters 201 and detractors 203. In addition, tracking of the Behavioral Promoter Score and analysis of historical data can occur on multiple levels, for example a customer level, an individual store level, a regional level, or other levels. This historical data analysis provides for situational recommendation of action on the appropriate level (customer, store, region, etc.) to improve the respective Behavioral Promoter Score. The recommended actions are generally selected to affect in a positive manner the dimensions that are important to customer(s) and drive the customer(s) to improved satisfaction with the retailer. The ability to complete this analysis at a variety of different levels is a significant improvement on the level of granularity a retailer can obtain through the use of solely survey based NPS tracking.

FIG. 2B shows a high-level diagram of how promoters 201 and detractors 203 are calculated in accordance with the preferred embodiment. The first step is research (205) to identify key drivers for the retailer customer. A driver can be anything that influences the customer's decision to use a particular retailer. Some examples of drivers are price of goods, store promotional items, services provided, quality of goods offered, choice of goods offered, store location, but this is not an exclusive list and there are many other possible drivers. As not all drivers are equally important to all customers, customer satisfaction is dependent on the drivers that are important to the individual customer making the necessity to use a sensitivity model 207 to discover accurately what elements of the retailers proposition will be most effective at creating a promoter or detractor. To determine which sensitivity model 207 to apply to a customer the customer's behavior 209. Customer indicators and customer responses are used to discover what drivers are important to the customer. Indicators are used to find customer groups with high dimension sensitivity, and responses, which are the direct observed dimension of specific behaviors. The information from the Behavioral Promotor Score than can be tracked over time and used as a basis to give recommended action to the retailer on how to improve customer relations, or make changes in the store to attract more customers.

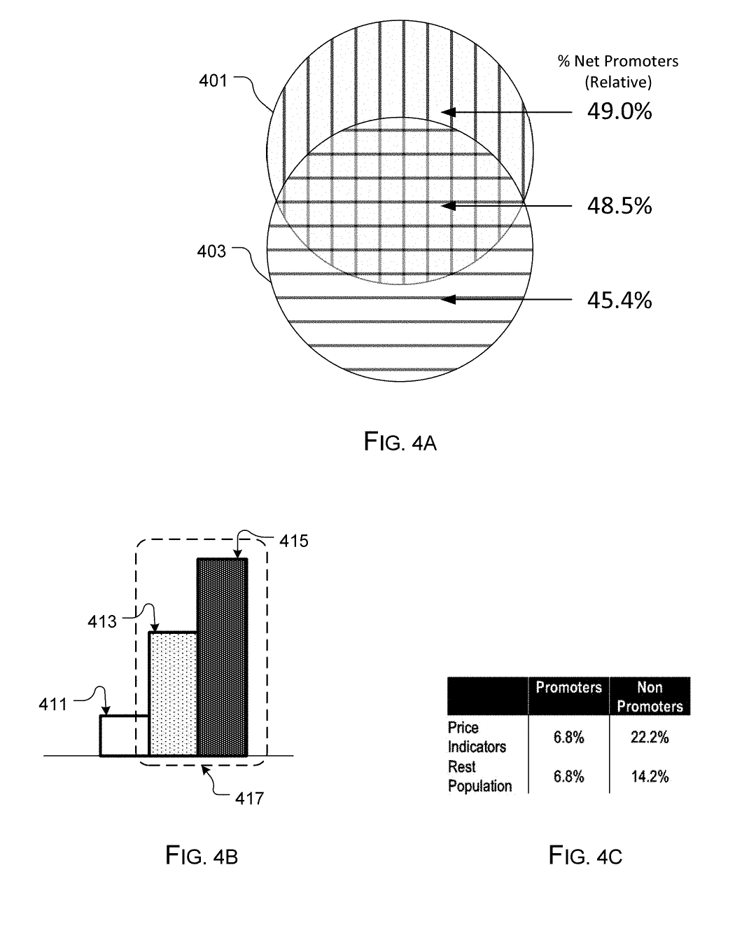

FIG. 3 is a flow chart depicting an enhanced customer segmentation (FACTS) system 301 in accordance with the preferred embodiment allows for the understanding of customer engagement. The Behavioral Promoter Score uses FACTS system 301 to provide a platform for diagnostic and opportunity assessment. Initially the FACTS system 301 checks to see if the customer buys key categories frequently 303. Then the enhanced customer segmentation (FACTS) system 301 places the customer in one of three customer categories (305, 307, 309) depending on the customer's shopping behaviors. Examples of these categories 305, 307, 309 may include: customer buys most key categories at retailer (305); customer buys some categories but shops elsewhere for many key lines (307); and customer does not buy any categories heavily at retailer (309). However, it should be appreciated that other categories may be used or added in other embodiments. Additional inputs are be used to discriminate attitude (for example sign up/usage of programs) alongside the FACTS framework where available

After categorizing the customer's shopping behaviors the FACTS system 301 checks that the customer's spending information is consistent (311, 313), unless the step is by-passed due to the customer category (307). If the customer category is 305 and the customer's spend information is consistent (311), then the customer always uses retailer as a primary sources for goods 315, including basic goods, making that customer a “heartland” customer (323). If the customer category is 305 and the customer's spend information is not consistent (311), then the customer sometimes uses competitors for major goods (317), sometimes including basic goods, making that customer a “battleground” customer (325). If the customer category is 307, the customer is a “battleground” customer 325. If the customer category is 309 and the customer's spend information is consistent (313), then the customer sometimes uses retailer for the major source of goods (319) making that customer a “battleground” customer 325. If the customer category is 309 and the customer's spend information is not consistent 313, then the customer never uses retailer as a major source of goods (321) making that customer a “wilderness” customer (327).

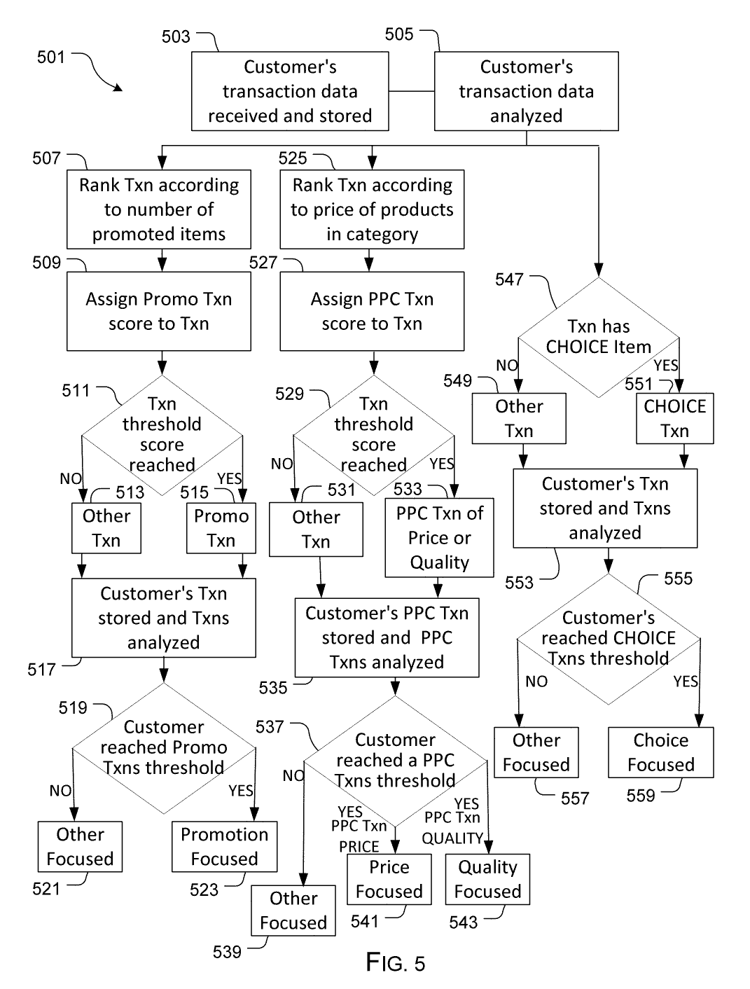

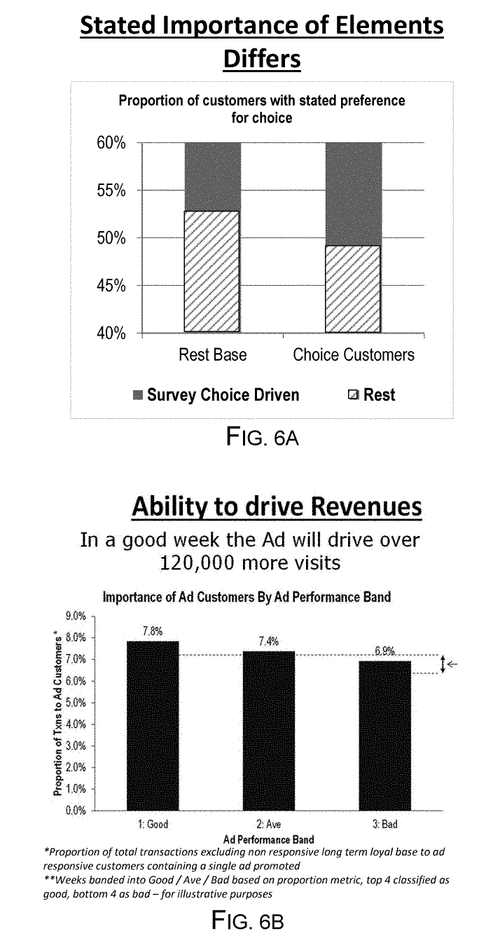

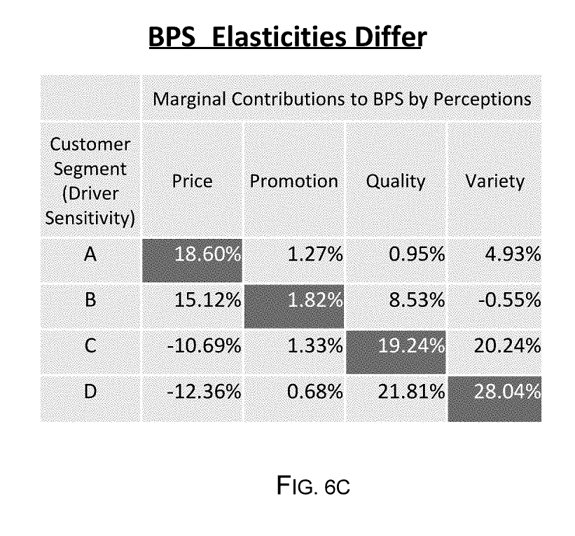

FIG. 4A is a chart showing likelihood to be a Net Promoter in accordance with the preferred embodiment. First circle 401 indicates customers in the “heartland” customer 323 group. Second circle 403 indicates top spending customer group. The “heartland” customer 323 is more likely to be a net promoter than a customer only in the high spend group. The standard net scoring system would indicate that a customer in the top spending customer group would be a net promoter, but that is erroneous. The Behavioral Promoter Score uses additional factors, which give a more accurate predication of which customers are net promoters.

FIG. 4B is a chart showing ability to drive revenues/margins in accordance with the preferred embodiment. In a typical retail store, the “wilderness” (or “tertiary”) customer will require a significant shift in a retailer's proposition to drive revenues/margins (411). Typically the “heartland” customer will require consistency and continuation of existing proposition to drive revenues/margins (413), whereas the “battleground” customer adjustments to specific elements in order to drive revenues/margins (415). The margin uplift (417) is the primary focus area for retailers. The margin uplift 417 is comprised of “heartland” and “battleground” customer's ability to drive revenues/margins 413, 415. The “battleground” customer's ability to drive revenues/margins 415 has the most potential due to it volatile nature.

FIG. 4C is a chart showing satisfaction with drivers in accordance with the preferred embodiment. In this example, promoters are consistently satisfied with price, whether or not sensitive. While customers who are price sensitive and non-promoters will be dissatisfied with price, which will indicate that price is an area that needs to be focus on to bring those “battleground” customers into the store.

FIG. 5 is a flow chart depicting a sample determination of customer sensitivity using a customer behavioral model 501 in accordance with the preferred embodiment. Initially, the customer's transaction data is received and stored (503). Next, the customer's transaction data is analyzed. The customer's transactions data is analyzed for all the key drivers that the retailer has selected, in this customer behavioral model example (501) only four key drivers are depicted (store promotional items, price of goods, quality of goods, and choice of goods); however it should be appreciated that in a full customer focus system all key drivers are analyzed. (Currently six dimensions are used, namely Price, Promotions, The Circular, Choice, Quality, and Direct Communication, but more may be used in the future.) For some key drivers the customer behavioral model 501 ranks the transaction according to given criteria (507, 525), while for other key drivers the customer behavioral model 501 may only check the transaction for a key driver 547 and then label the transaction as having the driver (551) or not (549). For key driver 547 there are a multitude of possible labels: a label may indicate that the product is a new product, that that customer buys a large repertoire of products, that the product is a niche product, or another label indicating that the product is of a choice type. It is possible for a transaction to have multiple labels.

For the key drivers that are ranked according to a given set of criteria (507, 525) the next step is assignment of a score to the transaction (407, 425). The score is generally determined by the number of articles in the transaction that fall under the key driver that is being indicated or it can be defined by the user. In cases after assigning a score to the transaction the customer behavioral model 501 checks to see if the transaction threshold score has been reached 409, 427, the threshold score can be determined by the individual retail user or provided by market research. If the threshold score is reached, the transaction is given the appropriate label (513, 533). If the threshold score is not reached, the transaction receives another transaction label (513, 531).

After the customer transactions have been labeled (513, 515, 531, 533, 549, 551), the customer behavioral model 501 checks the historical customer transactions and analyzes the data (517, 535, 553). Some data from the previous aggregation of transactions, some from the detail of individual item purchase. The customer behavioral model 501 checks to see whether the customer's behavior meets a certain threshold (519, 537, 555), which is determined by the application of models to match these behaviors to market research data. Depending on what thresholds are met, the customer is assigned certain focuses (521, 523, 539, 541, 543, 557, 559). It should be appreciated that a customer can be assigned more than one focus, and the customer's focuses will be used to determine the customer's sensitivities.

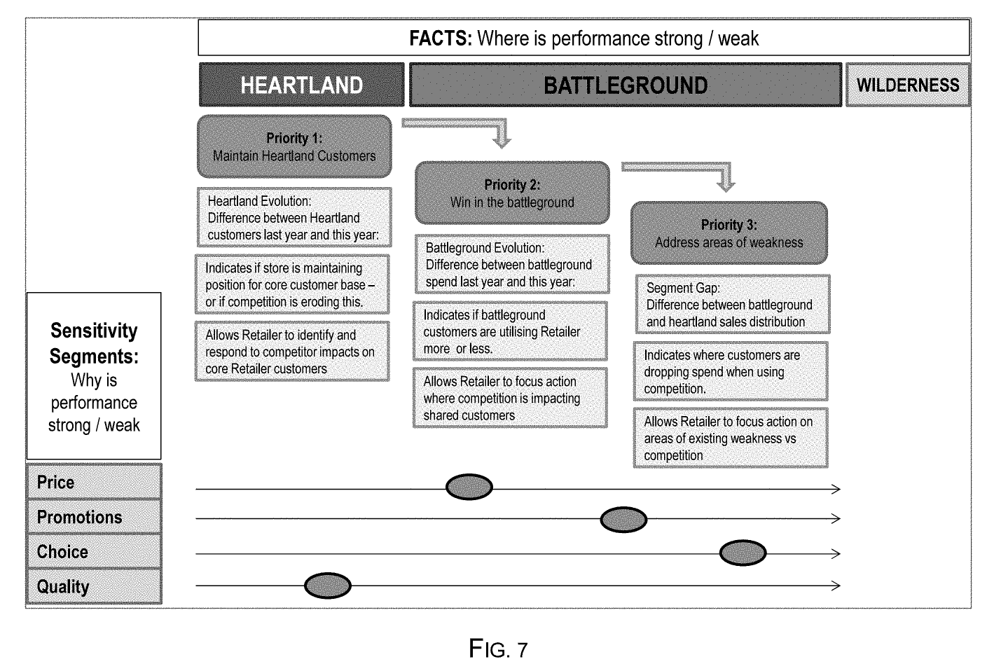

FIG. 6A, 6B, and 6C are charts showing that driver segmentation allows improved diagnosis in accordance with the preferred embodiment. FIG. 6A shows how the stated importance of elements can vary. This chart shows the proportion of customers with a stated preference for choice. It should be appreciated that the system is capable of producing reports and charts for other drivers and the information displayed in other ways. The sensitivity scores and segments are significant predictors of customers stated importance of drivers on overall satisfaction. The system allows the retailer to produce reports giving information on customer segments and drivers.

FIG. 6B shows how the system is capable to track a high impact activity, for example promotional communications. Tracking the performance of the activity on the sensitive customers allow the system to establish a link between customer segments and the overall performance.

FIG. 6C shows how the system can pin point areas where action is required. The sensitivity scores are segmentations provide differentiation across the “elasticity” of key drivers of overall customer satisfaction, which allows the retailer to focus on specific opportunities. The BPS elasticities differ chart shows for customer segments that are driver sensitive, but it should be appreciated that there can be more customer segments for a particular retailer. In addition, the drivers listed (price, promotion, quality, and variety) under the marginal contribution to BPS are generally considered to be core drivers, but the retailer could have additional drivers. In this paragraph the term “elasticity” is being used to describe the how variable response to customer behavior is reflected in the drivers.

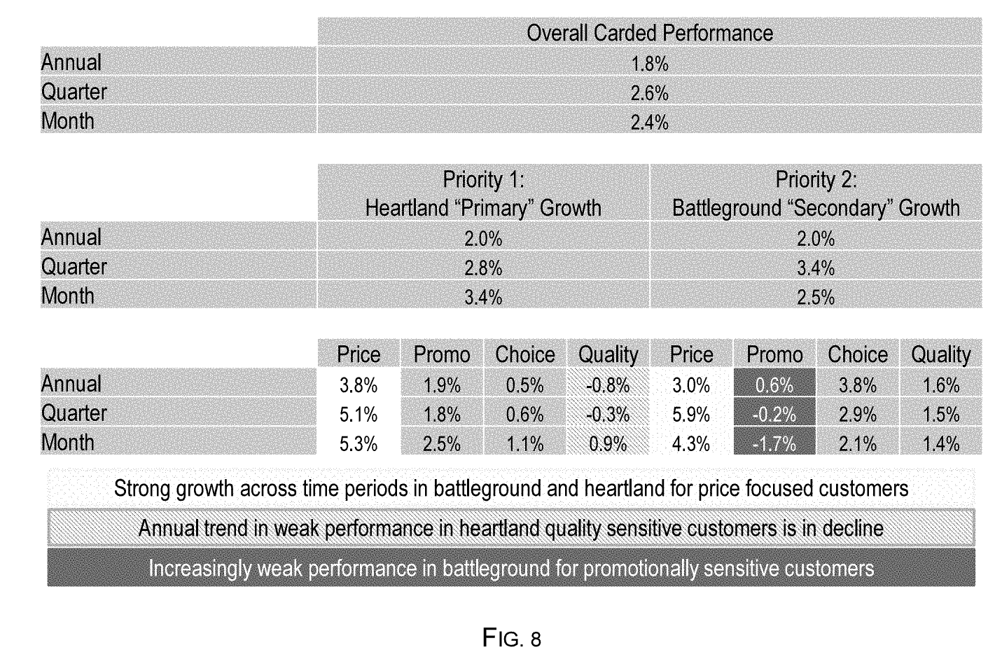

FIG. 7 shows an example of how FACTS data enables the system to identify opportunities in a competitive environment by understanding performance in accordance with the preferred embodiment. The system is capable of using FACTS to determine where the retailer performance is strong or weak. The system processes information for “heartland” customers: tracking the “heartland” customers' evolution from year to year; determining if the “heartland” customers are using the retailer more or less; and what sensitivity segments are most influencing the changes. The system also does similar processes for the “battleground” customers: tracking the “battleground” customers' evolution from year to year; determining if the “battleground” customers are using the retailer more or less; and what sensitivity segments are most influencing the changes. In addition, the system does a sales distribution gap analysis between the “battleground” and “heartland” customers, which indicates where customers are decreasing spending and using sensitivity segments the retailer is given the driver that needs to be improved.

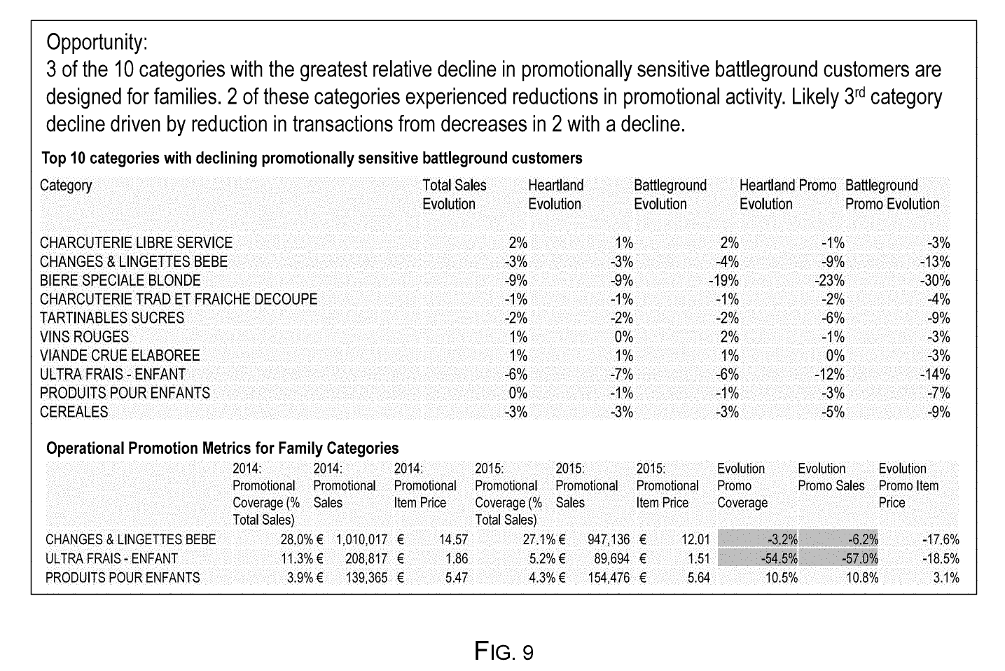

FIG. 8 shows an example of how the system can find weak performance in sensitivity segments even when the overall retailer is showing strong performance in accordance with the preferred embodiment. In this example, even though the retailer is showing a strong overall performance when the system breaks out the sensitivity segments details a different picture emerges. There is strong growth seen in price sensitivity segments for both the “heartland” and “battleground” customers, but both “heartland” and battleground” have an area showing weak performance. The “heartland” customers show an annual trend in weak performance in quality sensitive customers, which is improving; while the “battleground” customers show an increasingly weak performance for the promotionally sensitive customers.

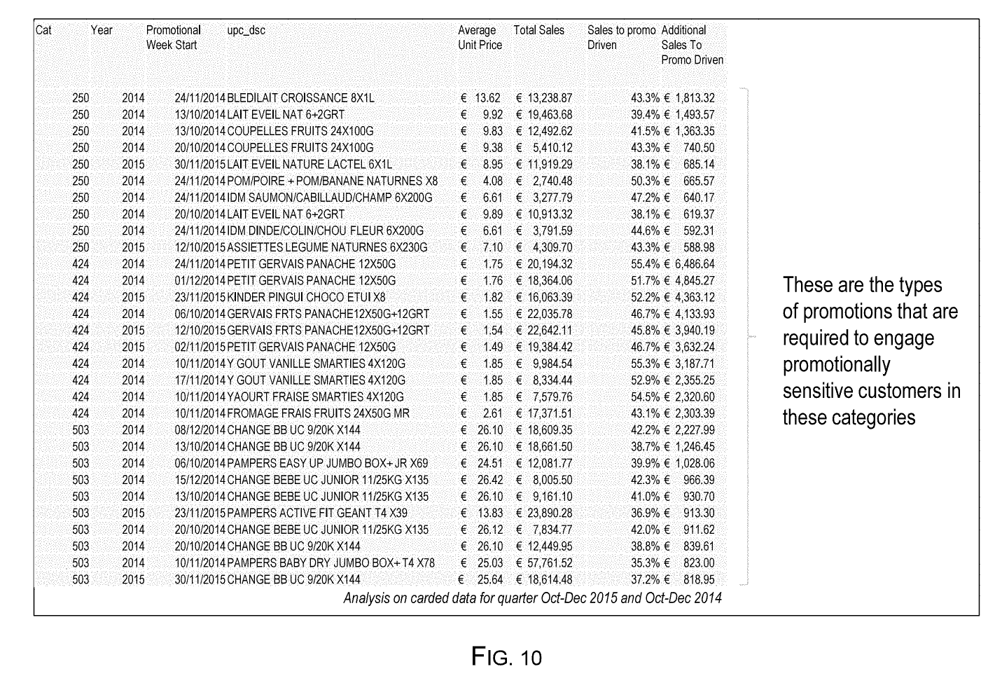

FIG. 9 shows an example of the system detailing what promotional activities likely caused the decline in the “battleground” customers in accordance with the preferred embodiment. The system is capable of discerning possible causes for weak performances in sensitivity segments. In this example, where the “battleground” customers have been increasingly weak in promotional items the system flagged that three of the ten categories with the greatest relative decline in the promotionally sensitive “battleground” customers are designed for families. Two of these categories experienced reduction in promotional activities and it is likely the third category decline is driven by a reduction in transaction from the decreases in the two with the decline.

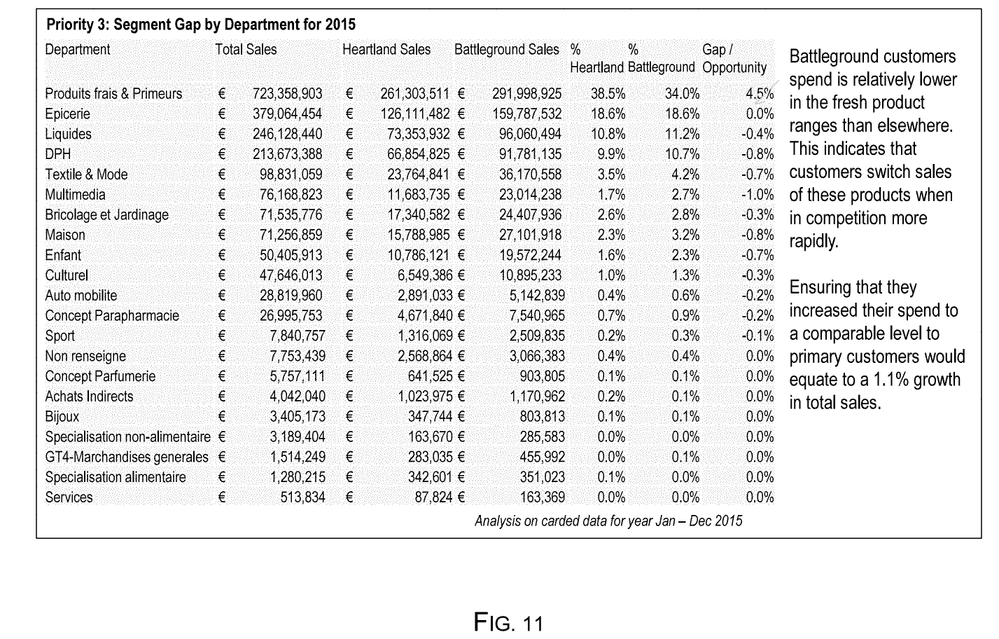

FIG. 10 shows the system is able to compare the number of promotions for declining sales items from year to year for analysis purposes in accordance with the preferred embodiment. In this example, the system was able to determine that seven of the top twenty promotions were for the family category where the decline now existed. In order to engage promotionally sensitive customers in these categories it is required to run these types of promotions.

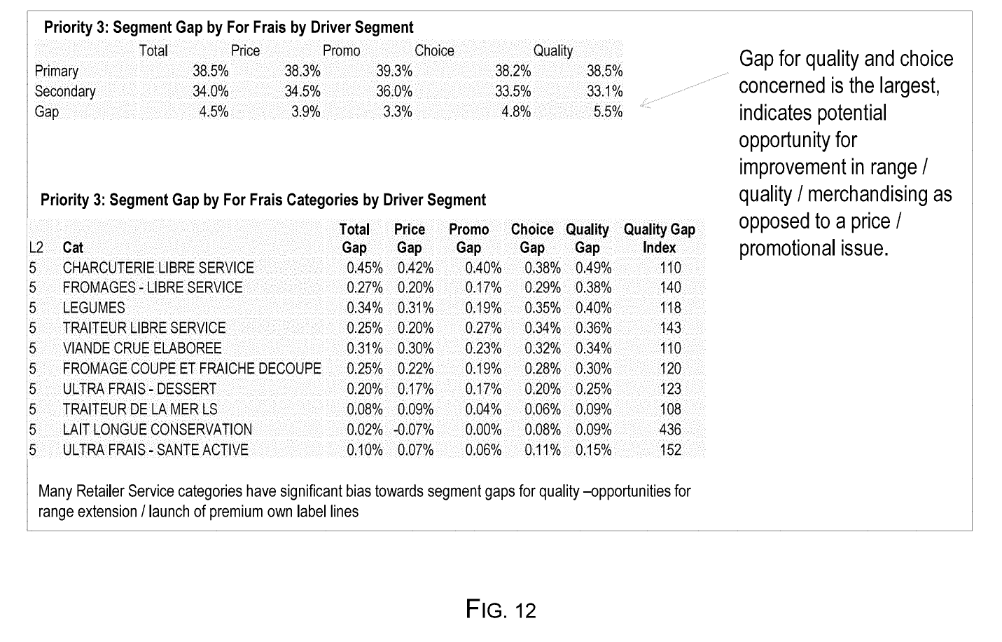

FIG. 11 shows the system is able to perform gap analysis in accordance with the preferred embodiment. In a gap analysis, the system takes sales from the “heartland” customers and compares them to the “battleground” customers. In this example, the “battleground” customers spend is relatively lower in the fresh produce ranges than elsewhere. This indicates that “battleground” customers switch sales of these products between competitors rapidly. If the retailer ensures that the “battleground” customers increases their spend level to comparable to the “heartland” customers, the retailer will see a 1.1% growth in total sales.

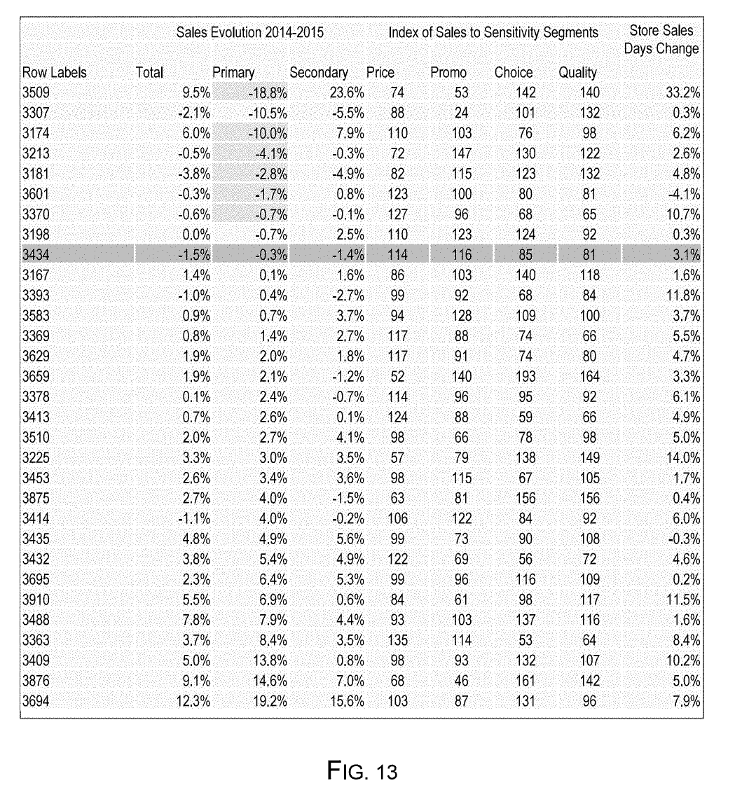

FIG. 12 shows how the system is able to determine a reason for the gap between “heartland” and “battleground” customers analysis in accordance with the preferred embodiment. In the example, the system identified the gap for quality and choice as areas of concern and with the largest opportunity potential for improvement in range, quality, and merchandizing as opposed to a pricing and promotional issue. Drilling down further on the quality sensitivity segment in the fresh produce section the system indicates that the retailer has an opportunity to improve the self-service area to win more “battleground” customers. There is an opportunity to either extend the retailers range in that area or launch their own premium label lines.

FIG. 13 shows the system offers the retailer a better understanding of their customer base allowing the retailer store to compete better locally in accordance with the preferred embodiment. The system shows the unique customer and competitive environment of each store along with the different challenges and opportunities facing the store. The system understands the opportunities and delivers propositions to the retailer to help the store thrive in the local environment. In this example, Store 3307 is losing “heartland” customers with a greater preference for quality; there is an opportunity for assortment and merchandising. In addition, store 3434 is losing “battleground” customers with a preference for value (price and promotion) bias in its customer base.

### Advantages

The disclosed innovations, in various embodiments, provide one or more of at least the following advantages. However, not all of these advantages result from every one of the innovations disclosed, and this list of advantages does not limit the various claimed inventions.
Improved Profitability of retail operations;
Optimized targeting of promotions;
Improved competitive advantage in battleground markets.

According to some but not necessarily all disclosed embodiments, there is provided: a method for managing a retail operation having multiple locations, comprising: a) identifying “heartland” customers, who are net promoters of the retail operation; b) identifying “battleground” customers, who shop with the retail operation and also with competitors; c) for both heartland and battlefield customers, and for specific product categories, and for specific retail locations, analyzing transactions to thereby derive customer behavior sensitivities to different specific elements of the store's proposition, including at least promotion, price, and quality; and segmenting customers into subgroups, according to their sensitivity to different specific elements of the store's proposition; and d) modifying the investment in different ones of the product segments, in dependence on step (c), in a direction that drives toward improved profitability.

According to some but not necessarily all disclosed embodiments, there is provided: a method for managing a retail operation, comprising: a) identifying “heartland” customers, who are net promoters of the retail operation; b) identifying “battleground” customers, who shop with the retail operation and also with competitors; c) for both heartland and battlefield customers, and for specific product categories, and analyzing transactions to thereby derive customer behavior sensitivities to different specific elements of the store's proposition, including at least promotion, price, and quality; and d) modifying the investment in different ones of the product segments, in dependence on the sensitivities derived in step (c), in a direction that drives toward improved profitability.

According to some but not necessarily all disclosed embodiments, there is provided: a method for managing a retail operation selling multiple product categories in multiple retail locations, comprising: a) identifying “heartland” customers, who are net promoters of the retail operation; b) identifying “battleground” customers, who shop with the retail operation and also with competitors; c) for both heartland and battlefield customers, and for specific ones of the product categories, and for specific ones of the retail locations, analyzing transactions to thereby derive customer behavior sensitivities to different specific elements of the store's proposition, including at least promotion, price, and quality; [and segmenting customers according to their sensitivity to different specific elements of the store's proposition;] and d) modifying the investment in different ones of the product segments, in dependence on step (c), in a direction that drives toward improved profitability.

According to some but not necessarily all disclosed embodiments, there is provided: a method for managing a retail operation selling multiple product categories in multiple retail locations, comprising: a) identifying “heartland” customers, who are net promoters of the retail operation; b) identifying “battleground” customers, who shop with the retail operation and also with competitors; c) for both heartland and battlefield customers, and for specific ones of the product categories, and for specific ones of the retail locations, analyzing transactions to thereby derive customer behavior sensitivities to different specific elements of the store's proposition, including at least promotion, price, and quality; and segmenting customers into subgroups, according to their sensitivity to different specific elements of the store's proposition; and d) modifying the investment in different ones of the product segments, in dependence on step (c), including the identified subgroups of customers, in a direction that drives toward improved profitability.

According to some but not necessarily all disclosed embodiments, there is provided: a computing system which receives data on specific retail transactions with at least some customer identifications, and accordingly for different specific customers, identifies different specific retail transactions for each, and groups customers into subgroups, not only by net promoter score and by store, but also by the sensitivity of the customers to particular elements of the retail proposition, and determines, for specific combinations of said subgroups with store location, actions which will predictably increase margin for individual ones of said specific combinations.

According to some but not necessarily all disclosed embodiments, there is provided: a computing system which receives data on specific retail transactions at multiple retail locations with at least some customer identifications, and accordingly for different specific customers, identifies different specific retail transactions for each, and groups customers into subgroups, not only by net promoter score and by location and by product category, but also by the sensitivity of the customers to particular elements of the retail proposition; wherein the particular elements include at least price, quality, and promotions; and accordingly determines, for specific combinations of said subgroups with store location and product category, actions which will predictably increase margin for individual ones of said specific combinations.

According to some but not necessarily all disclosed embodiments, there is provided: a computing system which receives data on specific retail transactions at multiple retail locations with at least some customer identifications, and accordingly for different specific customers, identifies different specific retail transactions for each, and groups customers into subgroups, not only by net promoter score and by location and by product category, but also by the sensitivity of the customers to particular elements of the retail proposition; wherein the particular elements include at least price, quality, and promotions; and accordingly determines, for specific combinations of said subgroups with store location and product category and net promoter type of specific customers, actions which will predictably increase margin for individual ones of said specific combinations.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications, and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method for managing a retail operation having multiple locations, comprising:
a) identifying “heartland” customers, who are net promoters of the retail operation;
b) identifying “battleground” customers, who shop with the retail operation and also with competitors;
c) for both heartland and battlefield customers, and for specific product categories, and for specific retail locations, analyzing transactions to thereby derive customer behavior sensitivities to different specific elements of the store's proposition, including at least promotion, price, and quality; and segmenting customers into subgroups, according to their sensitivity to different specific elements of the store's proposition; and
d) modifying the investment in different ones of the product segments, in dependence on step (c), in a direction that drives toward improved profitability.

2. The method of claim 1, wherein step (c) uses as inputs, for different respective customers, the frequency of that customer's visits to a specific location; the categories that customer buys at that retailer's store location, and that customer's total spend at the retail operation.

3. The method of claim 1, wherein step c uses as inputs, for different respective product segments, identification of purchased items as one or more of at least: basic goods; promotional goods; choice goods; low price goods; and quality goods.

4. The method of claim 1, wherein step d uses the sensitivities of heartland customers to drive strategy changes for battleground customers.

5. A method for managing a retail operation, comprising:
a) identifying “heartland” customers, who are net promoters of the retail operation;
b) identifying “battleground” customers, who shop with the retail operation and also with competitors;
c) for both heartland and battlefield customers, and for specific product categories, and analyzing transactions to thereby derive customer behavior sensitivities to different specific elements of the store's proposition, including at least promotion, price, and quality; and
d) modifying the investment in different ones of the product segments, in dependence on the sensitivities derived in step (c), in a direction that drives toward improved profitability.

6. The method of claim 5, wherein step (c) uses as inputs, for different respective customers: the frequency of that customer's visits to the retail operation's location; the categories that customer buys at the retailer's store location: and that customer's total spend.

7. The method of claim 5, wherein step (c) uses as inputs, for different respective product segments, identification of purchased items as one or more of at least: basic goods; promotional goods; choice goods; low price goods; and quality goods.

8. The method of claim 5, wherein step (d) uses the sensitivities of heartland customers to drive strategy changes for battleground customers.

9. A method for managing a retail operation selling multiple product categories in multiple retail locations, comprising:
a) identifying “heartland” customers, who are net promoters of the retail operation;
b) identifying “battleground” customers, who shop with the retail operation and also with competitors;
c) for both heartland and battlefield customers, and for specific ones of the product categories, and for specific ones of the retail locations, analyzing transactions to thereby derive customer behavior sensitivities to different specific elements of the store's proposition, including at least promotion, price, and quality; [and segmenting customers according to their sensitivity to different specific elements of the store's proposition;] and
d) modifying the investment in different ones of the product segments, in dependence on step (c), in a direction that drives toward improved profitability.

10. The method of claim 9, wherein step (c) uses as inputs, for different respective customers, the frequency of that customer's visits to the retail operation's location; the categories that customer buys at the retailer's store location, and that customer's total spend at the retail operation.

11. The method of claim 9, wherein step (c) uses as inputs, for different respective product segments, identification of purchased items as one or more of at least: basic goods; promotional goods; choice goods; low price goods; and quality goods.

12. The method of claim 9, wherein step (d) uses the sensitivities of heartland customers to drive strategy changes for battleground customers.

13-19. (canceled)
